(19) United States
(12) Patent Application Publication
(10) Pub. No.: US 2024/0266082 A1
(43) Pub. Date: Aug. 8, 2024

(54) NUCLEAR REACTOR COOLING MODULE, POWER GENERATION SYSTEM USING NUCLEAR REACTOR INCLUDING SAME, NUCLEAR REACTOR COOLING METHOD, AND NUCLEAR REACTOR DESIGN METHOD

(71) Applicants: IUCF-HYU (INDUSTRY-UNIVERSITY COOPERATION FOUNDATION HANYANG UNIVERSITY), Seoul (KR); KOREA ADVANCED INSTITUTE OF SCIENCE AND TECHNOLOGY, Daejeon (KR)

(72) Inventors: Sung Joong KIM, Seoul (KR); Ji Hun IM, Seoul (KR); Jae Hyung PARK, Seoul (KR); Ju Hyeong LEE, Seoul (KR); Yong Hee KIM, Daejeon (KR); Yun Sik CHO, Seoul (KR); Won Jun CHOI, Seoul (KR); Tae Suk OH, Daejeon (KR); Eun Hyung LEE, Daejeon (KR)

(73) Assignees: IUCF-HYU (INDUSTRY-UNIVERSITY COOPERATION FOUNDATION HANYANG UNIVERSITY), Seoul (KR); KOREA ADVANCED INSTITUTE OF SCIENCE AND TECHNOLOGY, Daejeon (KR)

(21) Appl. No.: 18/586,159

(22) Filed: Feb. 23, 2024

(30) Foreign Application Priority Data
Jan. 27, 2023 (KR) 10-2023-0011232

(51) Int. Cl. G21C 9/02; G21C 15/18

(52) U.S. Cl. CPC G21C 9/02; G21C 15/18

(57) ABSTRACT

Provided is a nuclear reactor cooling module including: a fluid line for providing a movement path for inert gas into a reactor; an inert salt liquid layer surrounding the reactor; and an inert salt solid layer surrounding the inert salt liquid layer and surrounded by the fluid line.

### BACKGROUND OF THE INVENTION

### 1. Field of the Invention

The present invention relates to a nuclear reactor cooling module, a power generation system using a nuclear reactor including the same, a nuclear reactor cooling method, and a nuclear reactor design method, and more particularly, to a nuclear reactor cooling module, a power generation system using a nuclear reactor including the same, a nuclear reactor cooling method, and a nuclear reactor design method, to provide an external discharge path to an internal molten salt upon occurring of an accident and phase-change inert salt from a solid phase to a liquid phase so as to be cooled.

### 2. Description of the Related Art

In general, nuclear reactors may refer to apparatuses for allowing fissile material, which is called nuclear fuel, to generate energy through nuclear reaction.

Among them, a molten salt reactor (MSR) may be a nuclear reactor in which nuclear fuel is melted together with salt, which is a coolant, and coexists in a liquid state, unlike a conventional nuclear reactor using solid nuclear fuel.

As described above, since the nuclear fuel exists in a liquid phase in the molten salt nuclear reactor, inherent safety is excellent due to a strong negative feedback effect caused by thermal expansion of the liquid nuclear fuel.

The molten salt in the molten salt reactor may be a mixture in which nuclear fuel materials, such as thorium, low-enriched uranium, spent nuclear fuel extract, and nuclear weapon decomposition fuel, chlorides, fluorides, and the like are mixed in various ways.

Accordingly, technologies on various molten salt nuclear reactors including various types of molten salts have been developed.

For example, Korean Patent Registered Publication No. 1017179420000 discloses a technology for a nuclear reactor including: a nuclear fuel assembly including a plurality of nuclear fuel bodies for causing nuclear fission chain reaction; a molten salt coolant disposed between the nuclear fuel bodies and including a molten salt component to absorb energy released by the nuclear fission chain reaction; and a reflector disposed to surround an outer wall of the nuclear fuel assembly and reduce external leakage of neutrons generated from the nuclear fuel assembly, wherein the molten salt coolant includes a nuclear fuel component of LiF—BeF2—ThF4—UF4, the LiF is 15 to 25 parts by weight, the BeF2 is 3 to 13 parts by weight, the ThF4 is 31 to 41 parts by weight, and the UF4 is 31 to 41 parts by weight, and a nuclear reactor core includes a small modular nuclear reactor core designed to be set from a subcritical state to a critical state in which an effective multiplication factor is 1 or more due to the molten salt coolant including the nuclear fuel component, and designed to be set from the critical state to a subcritical state in which the effective multiplication factor is less than 1 as the molten salt coolant leaks upon a coolant loss accident.

On the other hand, in viewpoint of the operating environments of the molten salt nuclear reactor, the molten salt reactor may be operated in a high temperature range at which the molten salt is melted, for example, a high temperature of 600° C. to 800° C.

In addition, the molten salt in the molten salt reactor contains highly radioactive materials such as fission products and nuclear materials, and the molten salt is composed of cations and anions to have polarity, thereby having strong corrosive properties against metal materials.

Accordingly, in the related art, there have been efforts for developing safety apparatuses on the operating environments with respect to high temperature, high radioactivity and strong corrosiveness as described above in order to operate the molten salt nuclear reactor.

For example, from a viewpoint of an operating environment related to the high temperature among the above-described operating environments of the molten salt nuclear reactor, a residual heat removal system for ensuring the safety of the nuclear reactor in a high-temperature operating environment has been developed in the related art.

However, since the residual heat removal system in the related art requires a wide installation space exceeding a space for installing the molten salt nuclear reactor, it may be inefficient in terms of space and cost.

Thus, there is a need for an apparatus capable of having efficient safety in the operating environment of the molten salt nuclear reactor.

### SUMMARY OF THE INVENTION

The present invention provides a nuclear reactor cooling module, a power generation system using a nuclear reactor including the same, a nuclear reactor cooling method, and a nuclear reactor design method, which have efficient safety when an accident occurs.

The present invention further provides a nuclear reactor cooling module, a power generation system using a nuclear reactor including the same, a nuclear reactor cooling method, and a nuclear reactor design method, in which a separate apparatus for cooling is not required.

The present invention still further provides a nuclear reactor cooling module, a power generation system using a nuclear reactor including the same, a nuclear reactor cooling method, and a nuclear reactor design method, which minimize emission of high-radioactive materials.

The technical problems to be solved by the present invention are not limited to the above description.

In order to solve the above-described technical problems, the present invention provides a nuclear reactor cooling module.

According to one embodiment, the nuclear reactor cooling module may include a fluid line for providing a movement path of inert gas into the nuclear reactor, an inert salt liquid layer surrounding the nuclear reactor, and an inert salt solid layer surrounding the inert salt liquid layer and surrounded by the fluid line.

According to one embodiment, the fluid line may surround the inert salt solid layer and be surrounded by a containment vessel for containing the nuclear reactor, and the molten salt discharged to a discharge path provided by the fluid line may exchange heat between the containment vessel and the inert salt solid layer.

According to one embodiment, the inert salt liquid layer may cool the nuclear reactor and block the discharge path of the molten salt to the outside of the containment vessel.

According to one embodiment, in the case of normal operation, the inert salt solid layer, as an inert salt solid, may form an insulation layer surrounding the inert salt liquid layer, thereby preserving heat of the nuclear reactor, and in the case of accident, the fluid line may block a movement path of the inert gas and provides the molten salt in the nuclear reactor with a discharge path from the inside of the nuclear reactor to the outside of the nuclear reactor, and the inert salt solid may be phase-changed into an inert salt liquid in a temperature range for melting the molten salt, through heat of the molten salt discharged to the discharge path provided by the fluid line surrounding the inert salt solid layer, thereby cooling the nuclear reactor.

In order to solve the above technical problems, the present invention provides a power generation system using a nuclear reactor and including a nuclear reactor cooling module.

According to one embodiment, the power generation system using the nuclear reactor may further include an auxiliary cooling unit for containing the nuclear reactor therein and cooling the containment vessel surrounding the fluid line.

According to one embodiment, the power generation system using the nuclear reactor may further include a fluid line heat exchanger for cooling the fluid line.

According to one embodiment, the power generation system using the nuclear reactor may further include: a gas tank for storing inert gas provided through the fluid line; and a fluid entrance provided at a lower side of the nuclear reactor to discharge the inert gas stored in the gas tank to an inner lower side of the nuclear reactor, wherein the gas tank may stop providing the inert gas when the accident occurs, and the molten salt inside the nuclear reactor may be introduced into the fluid entrance.

In order to solve the above technical problems, the present invention provides a nuclear reactor cooling method.

According to one embodiment, the nuclear reactor cooling method may include: causing a reaction through a molten salt inside a nuclear reactor; providing inert gas to an inside of the nuclear reactor through a fluid line; blocking a movement path of the inert gas through the fluid line when an accident occurs to provide the molten salt inside the nuclear reactor with a discharge path from the inside of the nuclear reactor to an outside of the nuclear reactor; surrounding an inert salt liquid layer surrounding the nuclear reactor, in which an inert salt solid of an inert salt solid layer surrounded by the fluid line is phase-transitioned into an inert salt liquid through heat of the molten salt discharged to the discharge path provided by the fluid line surrounding the inert salt solid layer; and cooling the nuclear reactor.

According to one embodiment, in the step of cooling, the molten salt may exchange heat between a containment vessel surrounding the fluid line and the inert salt solid layer.

According to one embodiment, in the step of causing the reaction, the inert salt liquid layer may cool the nuclear reactor and block the discharge path of the molten salt to an outside of the containment vessel.

According to one embodiment, in the step of causing the reaction, the inert salt solid layer may form an insulation layer by using the inert salt solid to preserve heat of the nuclear reactor, and in the step of phase-changing, the inert salt solid may be phase-transited to the inert salt liquid in a temperature range for melting the molten to cool the nuclear reactor.

In order to solve the above technical problems, the present invention provides a nuclear reactor design method.

According to one embodiment, the nuclear reactor design method, which is the method of designing a nuclear reactor including inert salt surrounding the nuclear reactor for accommodating a molten salt may include: designing the inert salt surrounding the nuclear reactor to be separated into an inert salt liquid layer disposed adjacent to the nuclear reactor and melted by heat generated from in the nuclear reactor, and an inert salt solid layer spaced apart from the nuclear reactor with the inert salt liquid layer interposed therebetween.

According to one embodiment, the nuclear reactor design method may further include: designing a fluid line that surrounds the inert salt solid layer and provides a movement path for inert gas into the nuclear reactor, and designing a containment vessel for surrounding the fluid line, wherein the molten salt discharged to the discharge path provided by the fluid line may be designed to exchange heat between the containment vessel and the inert salt solid layer.

According to the embodiments of the present invention, a nuclear reactor cooling module may be provided, which include: a fluid line for providing a movement path of inert gas into the nuclear reactor; an inert salt liquid layer for surrounding the nuclear reactor; and an inert salt solid layer for surrounding the inert salt liquid layer and surrounded by the fluid line.

Thus, according to the present invention, a separate apparatus for discharging the molten salt inside the nuclear reactor to the outside may be unnecessary when an accident occurs, so that the nuclear reactor can be efficiently cooled.

Therefore, according to the present invention, efficient safety can be implemented in terms of space and cost in operating environments of the nuclear reactor, that is, the molten salt nuclear reactor.

In addition, according to the embodiments of the present invention, the fluid line may surround the inert salt solid layer and be surrounded by the containment vessel for containing the nuclear reactor, and the molten salt discharged through the discharge path provided by the fluid line may exchange heat between the containment vessel and the inert salt solid layer.

Thus, according to the present invention, the nuclear reactor can be cooled, and since the nuclear reactor is stored inside the containment vessel, the release of highly radioactive materials contained in the molten salt inside the nuclear reactor can be minimized.

Therefore, according to the present invention, safety in the operation of the nuclear reactor can be improved.

### BRIEF DESCRIPTION OF THE DRAWINGS

FIG. 1 is a diagram for explaining a nuclear reactor according to the embodiments of the present invention.

FIGS. 2 to 7 are diagrams for explaining a nuclear reactor cooling method according to the embodiments of the present invention.

FIG. 8 is a diagram for explaining a nuclear reactor design method according to the embodiments of the present invention.

FIGS. 9 to 12 are diagrams for explaining experimental examples of the present invention.

### DETAILED DESCRIPTION OF THE INVENTION

Hereinafter, exemplary embodiments of the present invention will be described in detail with reference to the accompanying drawings. However, the technical idea of the present invention is not limited to the exemplary embodiments described herein and may be embodied in other forms. Further, the embodiments are provided to enable contents disclosed herein to be thorough and complete and provided to enable those skilled in the art to fully understand the idea of the present invention. -0 In the specification herein, when one component is mentioned as being on other component, it signifies that the one component may be placed directly on the other component or a third component may be interposed therebetween. In addition, in the drawings, thicknesses of shapes and areas may be exaggerated to effectively describe the technology of the present invention.

In addition, although terms such as first, second and third are used to describe various components in various embodiments of the present specification, the components will not be limited by the terms. The above terms are used merely to distinguish one component from another. Accordingly, a first component referred to in one embodiment may be referred to as a second component in another embodiment. Each embodiment described and illustrated herein may also include a complementary embodiment. In addition, the term “and/or” is used herein to include at least one of the components listed before and after the term.

The singular expression herein includes a plural expression unless the context clearly specifies otherwise. In addition, it will be understood that the term such as “include” or “have” herein is intended to designate the presence of feature, number, step, component, or a combination thereof recited in the specification, and does not preclude the possibility of the presence or addition of one or more other features, numbers, steps, components, or combinations thereof. In addition, the term “connection” is used herein to include both indirectly connecting a plurality of components and directly connecting the components.

In addition, the terms such as “ . . . unit”, “ . . . part” and “module” used in the specification refer to a unit configured to process at least one function or operation, which may be implemented as hardware, software, or a combination of hardware and software.

In addition, in the following description of the embodiments of the present invention, the detailed description of known functions and configurations incorporated herein will be omitted when it possibly makes the subject matter of the present invention unclear unnecessarily.

In general, nuclear reactors may refer to apparatuses for allowing fissile material, which is called nuclear fuel, to generate energy through nuclear reaction.

Among them, a molten salt reactor (MSR) may be a nuclear reactor in which nuclear fuel is melted together with salt, which is a coolant, and coexists in a liquid state, unlike a conventional nuclear reactor using solid nuclear fuel.

As described above, since the nuclear fuel exists in a liquid phase in the molten salt nuclear reactor, inherent safety is excellent due to a strong negative feedback effect caused by thermal expansion of the liquid nuclear fuel.

The molten salt in the molten salt reactor may be a mixture in which nuclear fuel materials, such as thorium, low-enriched uranium, spent nuclear fuel extract, and nuclear weapon decomposition fuel, chlorides, fluorides, and the like are mixed in various ways.

Accordingly, technologies on various molten salt nuclear reactors including various types of molten salts have been developed.

On the other hand, in viewpoint of the operating environments of the molten salt nuclear reactor, the molten salt reactor may be operated in a high temperature range at which the molten salt is melted, for example, a high temperature of 600° C. to 800° C.

In addition, the molten salt in the molten salt reactor contains highly radioactive materials such as fission products and nuclear materials, and the molten salt is composed of cations and anions to have polarity, thereby having strong corrosive properties against metal materials.

Accordingly, in the related art, there have been efforts for developing safety apparatuses on the operating environments with respect to high temperature, high radioactivity and strong corrosiveness as described above in order to operate the molten salt nuclear reactor.

For example, in viewpoint of an operating environment related to the high temperature among the above-described operating environments of the molten salt nuclear reactor, a residual heat removal system for ensuring the safety of the nuclear reactor in a high-temperature operating environment has been developed in the related art.

However, since the residual heat removal system in the related art requires a wide installation space exceeding a space for installing the molten salt nuclear reactor, it may be inefficient in terms of space and cost.

Thus, the present invention provides a nuclear reactor having efficient safety in the operating environment of the molten salt nuclear reactor.

Hereinafter, a nuclear reactor according to the embodiments of the present invention will be described with reference to the drawings.

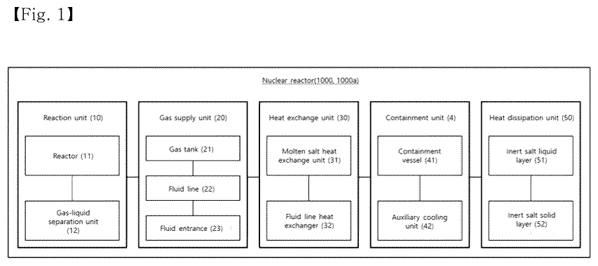

FIG. 1 is a diagram for explaining a nuclear reactor according to the embodiments of the present invention.

Referring to FIG. 1, A nuclear reactor 1000 may include at least one of a reaction unit 10, a gas supply unit 20, a heat exchange unit 30, a containment unit 40, and a heat dissipation unit 50.

Hereinafter, each configuration will be described.

Hereinafter, the nuclear reactor 1000 is assumed to be a molten salt reactor (MSR).

### Reaction Unit 10

In the reaction unit 10, a reaction can occur between substances within the nuclear reactor 1000, more specifically, at least two or more substances.

To this end, the reaction unit 10 may include at least one of a reactor 11 and a gas-liquid separation unit 12, as shown in FIG. 1.

Hereinafter, each configuration of the reaction unit 10 will be described.

### Reactor 11

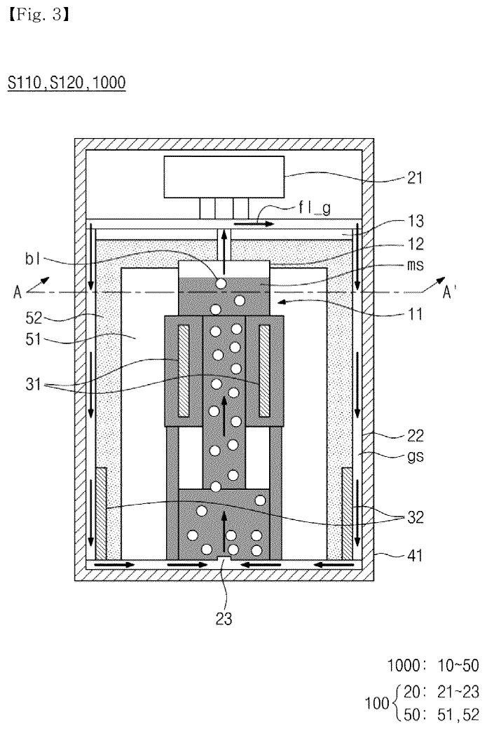

Referring to FIG. 3, in the reactor 11, a reaction may occur through molten salt ms.

More specifically, in the reactor 11, nuclear fuel material is eutectic in the molten salt ms, so that a nuclear reaction may occur in a liquid state in which nuclear fuel and coolant are integrated.

Accordingly, energy may be generated from the nuclear fuel eutectic in the molten salt ms, in the reactor 11.

### Gas-Liquid Separation Unit 12

Referring to FIG. 3, the molten salt ms and gas bl may be separated in the gas-liquid separation unit 12.

More specifically, the molten salt ms and the gas bl obtained by collecting non-soluble particles (not shown) inside the molten salt ms may be separated from each other in the gas-liquid separation unit 12.

To this end, referring to FIG. 3, the gas supply unit 20 described later may be connected to a lower side of the reactor 11 to provide inert gas gs as a source of the gas bl. The gas supply unit 20 will be described in detail later.

Accordingly, when the gas bl is provided to the lower inside of the reactor 11 from the gas supply unit 20 described later, the gas bl may be formed as air bubbles, that is, bubbles bl inside the molten salt ms of the reactor 11, and the bubble bl may be moved from the lower side to an upper side of the reactor 11 and burst in the gas-liquid separation unit 12.

As described above, the gas, that is, the bubble bl, collects the non-soluble particles (not shown). When the bubble bl bursts in the gas-liquid separation unit 12, the non-soluble particles (not shown) may fall from the bubble bl into a predetermined space inside the nuclear reactor 1000, such as a collection space (not shown) for collecting the non-soluble particles (not shown).

Meanwhile, herein, non-soluble particles (not shown) may refer to non-soluble nuclear fission products that are non-dissolved inside the nuclear reactor 1000. More specifically, the non-soluble nuclear fission products may be materials produced when nuclear fuel materials are eutectic in the molten salt ms to cause a nuclear reaction in the reactor 11 described above. For example, the non-soluble nuclear fission products may be noble metal-based nuclear fission products. However, the non-soluble particles (not shown) are not limited to the above-described noble metals, and are not limited as long as they are nuclear fission products that are non-dissolved inside the nuclear reactor 1000.

Thus, according to the present invention, the molten salt ms and the gas bl obtained by collecting the non-soluble particles (not shown) inside the molten salt ms are separated in the gas-liquid separation unit 12, so that the above-described non-soluble fission products may be separated from the molten salt ms inside the nuclear reactor 1000 and managed.

Meanwhile, unlike the embodiment of the present invention, when non-soluble nuclear fission products are non-dissolved and exist inside the nuclear reactor, the non-soluble nuclear fission products are not be dissolved in the molten salt and the liquid nuclear fuel, which are solvents, and therefore may be locally deposited inside the nuclear reactor.

When the non-soluble fission products are locally deposited inside the nuclear reactor, local system materials of the nuclear reactor may be embrittled.

Further, the lifespan of the nuclear reactor may be shortened eventually.

In particular, when the non-soluble nuclear fission products are deposited on a surface of a heat exchanger having a relatively low temperature inside the nuclear reactor, the performance of the heat exchanger may be deteriorated.

However, according to the embodiments of the present invention, as described above, the molten salt ms and the gas bl obtained by collecting the non-soluble particles (not shown) inside the molten salt ms are separated in the gas-liquid separation unit 12, so that the non-soluble nuclear fission products may be separated from the molten salt ms inside the nuclear reactor 1000 and managed.

Thus, according to the present invention, the local deposition of the non-soluble nuclear fission products inside the nuclear reactor 1000 can be minimized.

Therefore, according to the present invention, because the local deposition of the non-soluble nuclear fission products inside the nuclear reactor 1000 is minimized, the lifespan of the nuclear reactor 1000 can be extended.

In addition, since the deposition of the non-soluble nuclear fission products is minimized on the surface of the molten salt heat exchanger 31 (see FIG. 3) having a relatively low temperature inside the nuclear reactor 1000, the performance degradation of the molten salt heat exchanger 31 (see FIG. 3) can be minimized.

### Gas Supply Unit 20

The gas supply unit 20 may provide the inert gas gs as a source of the gas bl into the reactor 11.

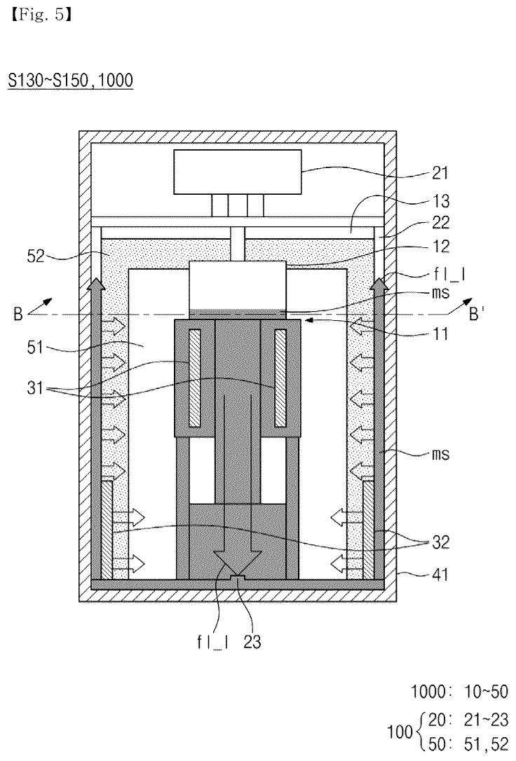

Referring to FIG. 5, the gas supply unit 20 may provide the molten salt ms inside the reactor 11 to the outside of the reactor 11.

To this end, as shown in FIG. 1, the gas supply unit 20 may include at least one of a gas tank 21, a fluid line 22, and a fluid entrance 23.

Hereinafter, each configuration of the gas supply unit 20 will be described.

### Gas Tank 21

The gas tank 21 may store the inert gas gs.

Referring to FIG. 3, the gas tank 21 may provide the stored inert gas gs into the reactor 11.

More specifically, referring to FIG. 3, the inert gas gs stored in the gas tank 21 may be moved along a movement path fl_g provided by the fluid line 22 described later and provided to a lower inside of the reactor 11 through the fluid entrance 23 described later.

Meanwhile, according to the embodiments of the present invention, the gas tank 21 may stop providing the inert gas gs when an accident occurs. Herein, the accident may be understood as a concept that includes a state in which operation of the nuclear reactor 1000 is impossible. For example, the accident herein may be understood as a concept that includes cases in which power cannot be supplied to the nuclear reactor 1000, an operating temperature of the nuclear reactor 1000 exceeds a reference range for operation, and an error occurs beyond a normal range of the nuclear reactor 1000. In other words, the interruption of the provision of the inert gas gs from the gas tank 21 may be caused by, for example, loss of function due to non-supply of power when the power cannot be supplied to the nuclear reactor 1000 is impossible, as described above.

Thus, according to the embodiments of the present invention, when the accident occurs and the gas tank 21 stops providing the inert gas gs, as shown in FIG. 5, the molten salt ms inside the reactor 11 may be provided with a discharge path fl_l from the inside of the reactor 11 to the outside. This will be described later in more detail.

### Fluid Line 22

Referring to FIG. 3, the fluid line 22 may provide the movement path fl_g for the inert gas gs into the reactor 11.

To this end, one side of the fluid line 22 may be connected to the gas tank 21, and the other side may be connected to the fluid entrance 23 described later.

Meanwhile, according to the embodiments of the present invention, when the accident occurs, the gas tank 21 may stop providing the inert gas gs as described above, and thus, the movement path fl_g of the inert gas gs may be blocked through the fluid line 22.

Therefore, when the movement path fl_g of the inert gas gs is blocked through the fluid line 22, the fluid line 22 may provide the discharge path fl_l from the inside of the reactor 11 to the outside for the molten salt ms inside the reactor 11 as shown in FIG. 5.

According to the embodiments of the present invention, the discharge path fl_l is provided to the molten salt ms through the fluid line 22 because a pressure inside the fluid line 22 may become lower than a pressure inside the reactor 11 when the movement path fl_g of the inert gas gs is blocked through the fluid line 22 as described above.

Thus, referring to FIG. 5, when the accident occurs, the molten salt ms inside the reactor 11 may be discharged from inside the reactor 11 to the outside through the discharge path fl_l provided by the fluid line 22.

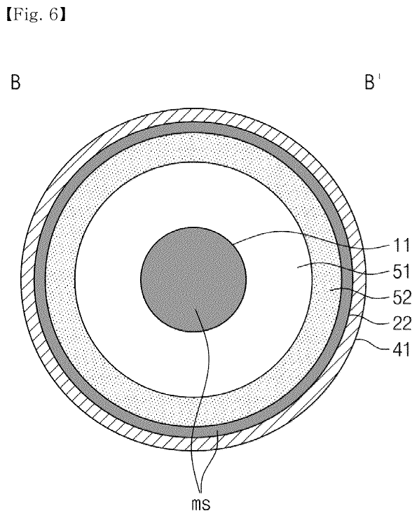

Meanwhile, referring to FIGS. 5 and 6, the fluid line 22 surrounds an inert salt solid layer 52 described later, and accordingly, due to heat of the molten salt ms discharged through the discharge path fl_l provided by the fluid line 22, an inert salt solid of the inert salt solid layer 52 described later may be phase-changed into an inert salt liquid.

The inert salt solid and the inert salt liquid have similar thermal conductivities, however, the inert salt liquid may have better heat transfer characteristics than the inert salt solid due to a convection phenomenon.

Thus, in the case of the accident, when the inert salt solid of the inert salt solid layer 52 is phase-changed into the inert salt liquid, the reactor 11 may be cooled through the inert salt liquid having the better heat transfer properties than the inert salt solid as described above.

Thus, according to the present invention, when the accident as described above occurs, a separate apparatus for discharging the molten salt ms inside the reactor 11 to the outside is unnecessary, and therefore, the reactor 11 can be efficiently cooled.

Thus, according to the present invention, in the operating environment of the nuclear reactor 1000, that is, the molten salt nuclear reactor, efficient safety can be achieved from the viewpoint of space and cost.

Meanwhile, as described above, when the accident occurs and the molten salt ms inside the reactor 11 flows, through the discharge path fl_l provided by the fluid line 22, is discharged from the inside to the outside, the inert salt solid of the inert salt solid layer 52 described later may be phase-changed into the inert salt liquid.

To this end, referring to FIGS. 5 and 6, the fluid line 22 may surround the inert salt solid layer 52 described later.

Thus, according to the present invention, the inert salt solid may be phase-changed into the inert salt liquid through the heat of the molten salt ms discharged to the discharge path fl_l provided by the fluid line 22 surrounding the inert salt solid layer 52 described later.

Thus, according to the present invention, the reactor 11 may be cooled. This will be described in more detail later.

### Fluid Entrance 23

Referring to FIG. 3, the inert gas gs stored in the gas tank 21 may be discharged from the lower inside of the reactor 11 through the fluid entrance 23.

To this end, the fluid entrance 23 may be provided at the lower side of the reactor 11 as shown in FIG. 3.

Meanwhile, according to the embodiments of the present invention, when the accident occurs, as shown in FIG. 5, molten salt ms inside the reactor 11 may be introduced into the fluid entrance 23.

This is because, as described above, the gas tank 21 when the accident occurs may stop providing the inert gas gs, accordingly, the fluid line 22 may block the movement path fl_g of the inert gas gs, and therefore, the pressure inside the fluid line 22 may become lower than the pressure inside the reactor 11.

Thus, referring to FIG. 5, when the accident occurs, the molten salt ms into the reactor 11 may be introduced to the inside of the reactor 11 through the fluid entrance 23.

Accordingly, the molten salt ms inside the reactor 11 may be discharged to the outside of the reactor 11 through the discharge path fl_l provided by the fluid line 22.

Meanwhile, referring to FIGS. 5 and 6, since the fluid line 22 surrounds the inert salt solid layer 52 described later as described above, the inert salt solid of the inert salt solid layer 52 described later may be phase-changed into the inert salt liquid by the heat of the molten salt ms) discharged through the discharge path fl_l provided by the fluid line 22.

The inert salt solid and the inert salt liquid have similar thermal conductivities, however, the inert salt liquid may have better heat transfer characteristics than the inert salt solid due to a convection phenomenon.

Thus, in the case of the accident, when the inert salt solid of the inert salt solid layer 52 is phase-changed into the inert salt liquid, the reactor 11 may be cooled through the inert salt liquid having the better heat transfer properties than the inert salt solid as described above.

Thus, according to the present invention, as described above, when the accident occurs, a separate apparatus for discharging the molten salt ms inside the reactor 11 to the outside is unnecessary, and the reactor 11 can be cooled in the efficient manner.

Thus, according to the present invention, as described above, the efficient safety can be achieved from the viewpoint of space and cost in the operating environment of the nuclear reactor 1000, that is, the molten salt nuclear reactor.

### Heat Exchange Unit 30

The heat exchange unit 30 may cool the molten salt ms inside the reactor 11.

Meanwhile, the heat exchange unit 30 may also cool the fluid line 22.

To this end, as shown in FIG. 1, the heat exchange unit 30 may include at least one of a molten salt heat exchange unit 31 and a fluid line heat exchange unit 32.

Hereinafter, each configuration of the heat exchange unit 30 will be described.

### Molten Salt Heat Exchange Unit 31

Referring to FIG. 3, the molten salt heat exchange unit 31 may cool the molten salt ms inside the reactor 11.

To this end, the molten salt heat exchange unit 31 may 31 may be provided on one side of the reactor 11.

Accordingly, the molten salt heat exchange unit 31 can cool the molten salt ms inside the reactor 11. Thus, when the molten salt ms is cooled, the cooled molten salt ms may be circulated and used inside the reactor 11.

### Fluid Line Heat Exchanger 32

Referring to FIG. 5, the fluid line heat exchanger 32 may cool the fluid line 22.

To this end, the fluid line heat exchange unit 32 may be provided on one side of the fluid line 22.

Accordingly, when the accident occurs, the fluid line heat exchange unit 32, as shown in FIG. 5, may cool the molten salt ms discharged to the discharge path fl_l provided by the fluid line 22. Therefore, the nuclear reactor 1000 can be cooled.

According to one embodiment, the fluid line heat exchanger 32 may be a heat pipe. However, it is obvious to those skilled in the art that the practical implementation of the fluid line heat exchange unit 32 is not limited to the heat pipe from the technical idea according to the embodiments of the present application.

### Containment Unit 40

The containment unit 40 may contain the reaction unit 10 therein.

To this end, the containment unit 40 may include a containment vessel 41 as shown in FIG. 1.

Meanwhile, according to the nuclear reactor 1000a in one modification of the present invention, the containment unit 40 may further include an auxiliary cooling unit 42 for cooling the containment vessel 41.

Hereinafter, each configuration of the containment unit 40 will be described.

### Containment Vessel 41

Referring to FIG. 5, the containment vessel 41 may contain the reaction unit 10, more specifically, at least one of the reactor 11 and the gas-liquid separation unit 12.

Meanwhile, as described above, the molten salt ms inside the reactor 11 contains highly radioactive materials such as nuclear fission products and nuclear materials. According to the present invention, when the containment vessel 41 contains the reactor 11, the release of the above-described highly radioactive materials to the outside of the reactor 11 can be minimized.

Thus, according to the present invention, the safety can be improved in the operation of the nuclear reactor 1000.

Meanwhile, the containment vessel 41 may surround the fluid line 22, as shown in FIG. 5.

Accordingly, as described above, when the accident occurs, the molten salt ms discharged to the discharge path fl_l provided by the fluid line 22 may exchange heat between the containment vessel 41 and the inert salt solid layer 52 described later.

Thus, according to the present invention, the nuclear reactor 1000 can be cooled.

According to the embodiments, a support structure 13 may be provided within the containment vessel 41. The support structure 13 may have a disc shape as a plate and be provided on the inert salt solid layer 52 without being submerged in the inert salt solid layer 52 to support various apparatuses that may be provided at an upper portion of the containment vessel 41.

Alternatively, unlike the above description, according to another embodiment, an empty space 13 may be provided in the containment vessel 41. The empty space 13 may function to alleviate thermal expansion of the inert salt solid layer 52 and/or the inert salt liquid layer 51, and as a result, the containment vessel 41 can be stably maintained from thermal expansion of the inert salt solid layer 52 and the inert salt liquid layer 51.

### Auxiliary Cooling Unit 42

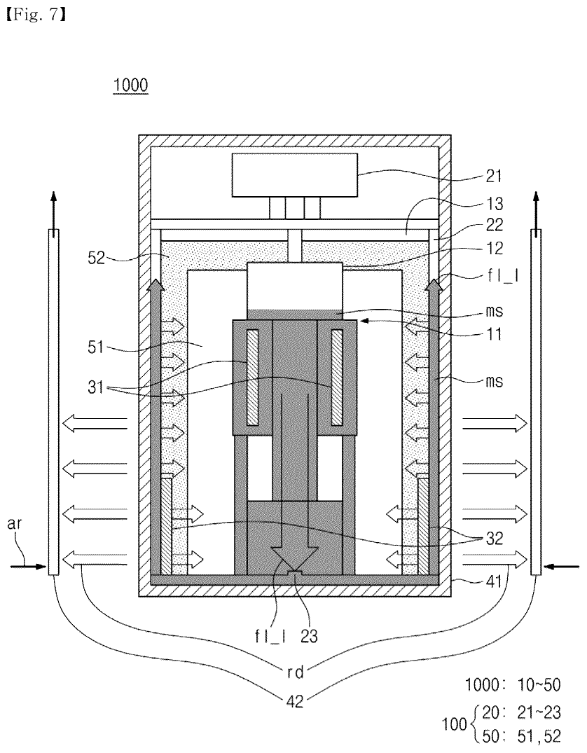

According to the nuclear reactor 1000a in one modification of the present invention, the nuclear reactor 1000a may further include an auxiliary cooling unit 42 as shown in FIG. 7.

The auxiliary cooling unit 42 may cool the containment vessel 41.

To this end, the auxiliary cooling unit 42 may be provided on one side of the containment vessel 41 or may be provided to surround at least a part of the containment vessel 41.

Accordingly, as described above, when the accident occurs and the molten salt ms discharged to the discharge path fl_l provided by the fluid line 22 exchanges the heat between the containment vessel 41 and the inert salt solid described later, the auxiliary cooling unit 42 may radiate rd the heat from the containment vessel 41 to the outside of the containment vessel 41.

Therefore, the containment vessel 41 may be cooled.

### Heat Dissipation Unit 50

The heat dissipation unit 50 may preserve the heat of the reactor 11, and release the heat to the outside of the reactor 11 when the accident occurs, so that the reactor 11 may be cooled.

Meanwhile, the heat dissipation unit 50 may block the discharge path of the molten salt ms to the outside of the containment vessel 41.

To this end, the heat dissipation unit 50 may include at least one of the inert salt liquid layer 51 and the inert salt solid layer 52, as shown in FIG. 1.

Hereinafter, each configuration of the heat dissipation unit 50 will be described.

### Inert Salt Liquid Layer 51

Referring to FIG. 3, the inert salt liquid layer 51 may be provided to surround the reactor 11.

Meanwhile, since the reactor 11 is operated at a high temperature range, for example, 600° C. or higher and 800° C. or lower or lower, at which the molten salt ms is melted, the inert salt included in the inert salt liquid layer 51 surrounding the reactor 11 may be present in a liquid state, that is, in an inert salt liquid.

To this end, the inert salt may be a material that has a liquid phase in the temperature range at which the molten salt ms is melted. Meanwhile, the inert salt may be a material that is not reacted inside the nuclear reactor 1000. For example, the inert salt may be at least one of chloride-based, fluorine-based, and nitric acid-based materials. More specifically, for example, the inert salt may be selected from the group including at least one of potassium chloride (KCl) and sodium chloride (NaCl). However, the inert salt is not limited to the above-described embodiment, and is a material that has a liquid phase as described above in the temperature range at which the molten salt ms is melted, but there is no limitation as long as it is a material that is not reacted inside the nuclear reactor 1000, for example, a material that is not reacted with the molten salt ms.

Meanwhile, referring to FIG. 3, since the inert salt liquid layer 51 is provided to surround the reactor 11 as described above, the reactor 11 may be cooled.

This may be because, as described above, when the inert salt exists in a liquid state, heat transfer characteristics are superior to when it exists in a solid state due to a convection phenomenon.

Thus, the inert salt liquid layer 51 can cool the reactor 11.

Meanwhile, as described above, since the inert salt liquid layer 51 is provided to surround the reactor 11, the inert salt liquid layer 51 may block the discharge path of the molten salt ms to the outside of the containment vessel 41.

As described above, this may be because the inert salt of the inert salt liquid layer 51 is the material that is not reacted inside the nuclear reactor 1000, more specifically, the material that is not reacted with the molten salt ms.

Therefore, even when the molten salt ms inside the reactor 11 is discharged to the outside of the reactor 11, the discharge path of the molten salt ms may be blocked by the inert salt of the inert salt liquid layer 51 surrounding the reactor 11.

### Inert Salt Solid Layer 52

Referring to FIG. 3, the inert salt solid layer 52 may be provided to surround the inert salt liquid layer 51.

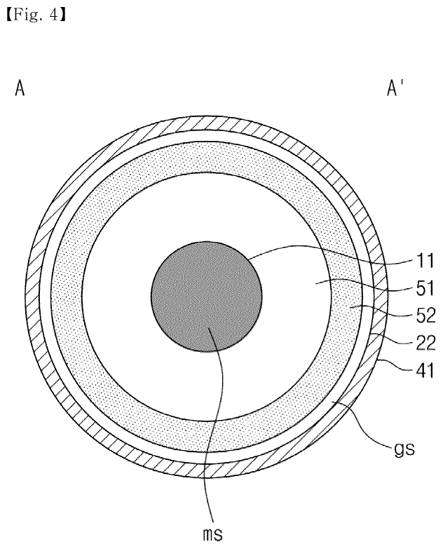

As described above, since the inert salt liquid layer 51 surrounds the reactor 11, the inert salt contained in the inert salt liquid layer 51 exists in a liquid state due to the high temperature as described above. Whereas, since the inert salt solid layer 52 surrounds the inert salt liquid layer 51, which has a temperature lower than that of the reactor 11 as shown in FIGS. 3 and 4, the inert salt included in the inert salt solid layer 52 may exist in a solid state due to the low temperature as described above.

Accordingly, before the above-described accident as occurs, that is, in the case of normal operation, the inert salt solid layer 52 may form an insulating layer surrounding the inert salt liquid layer 51 by using the inert salt in the solid state, that is, the inert salt solid.

Thus, the heat of the reactor 11 can be preserved.

Meanwhile, referring to FIG. 5, when the accident occurs, as described above, the molten salt ms inside the reactor 11 may be discharged from the inside of the reactor 11 to the outside through the discharge path fl_l provided by the fluid line 22.

Meanwhile, referring to FIGS. 5 and 6, the inert salt solid layer 52 is surrounded by the fluid line 22, and the inert salt solid of the inert salt solid layer 52 may be phase-changed into the inert salt liquid by the heat of the molten salt ms discharged through the discharge path fl_l provided by the fluid line 22.

To this end, the inert salt solid of the inert salt solid layer 52 may be a material that is phase-changed into the inert salt liquid in a temperature range at which the molten salt ms is melted.

According to one embodiment, the inert salts forming the inert salt liquid layer 51 and the inert salt solid layer 52 may be the same. According to another embodiment, the inert salts forming the inert salt liquid layer 51 and the inert salt solid layer 52 may be different from each other. For example, the inert salt may be selected from the group including at least one of potassium chloride (KCl) and sodium chloride (NaCl), as described above. However, the inert salt is not limited to the above-described embodiments, and as described above, and there is no limitation as long as it is a material a material that is non-reacted inside the nuclear reactor 1000, for example, non-reacted with the molten salt ms, so as to be phase-changed from the inert salt solid to the inert salt liquid in the temperature range at which the molten salt ms is melted.

Meanwhile, as described above, the inert salt solid and the inert salt liquid have similar thermal conductivities, however, the inert salt liquid may have better heat transfer characteristics than the inert salt solid due to a convection phenomenon.

Thus, in the case of the accident, when the inert salt solid of the inert salt solid layer 52 is phase-changed into the inert salt liquid, the reactor 11 may be cooled through the inert salt liquid having the better heat transfer properties than the inert salt solid as described above.

Thus, according to the present invention, when the accident as described above occurs, a separate apparatus for discharging the molten salt ms inside the reactor 11 to the outside is unnecessary, and therefore, the reactor 11 can be efficiently cooled.

Thus, according to the present invention, in the operating environment of the nuclear reactor 1000, that is, the molten salt nuclear reactor, efficient safety can be achieved from the viewpoint of space and cost.

The nuclear reactors 1000 and 1000a according to the embodiments of the present invention have been described.

Hereinafter, a nuclear reactor cooling method according to the embodiments of the present invention will be described with reference to the drawings. In the nuclear reactor cooling method according to the embodiments of the present invention described below, descriptions overlapping with the previously described nuclear reactors 1000 and 1000a may be omitted. However, the omission of overlapping descriptions below does not signify that the features according to the present invention are excluded, and the description of the previous embodiment will be referred to for overlapping descriptions below.

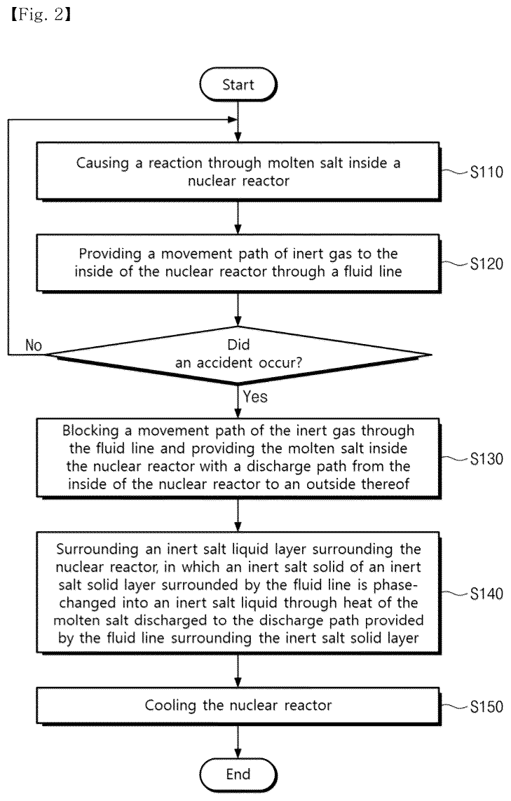

FIGS. 2 to 7 are diagrams for explaining a nuclear reactor cooling method according to the embodiments of the present invention.

Referring to FIG. 2, the method of cooling the nuclear reactor 1000 and 1000a may include at least one of: a step (S110) of causing a reaction through the molten salt ms inside the reactor 11; a step (S120) providing the inert gas gs into the reactor 11 through the fluid line 22; a step (S130) of blocking the movement path fl_g of the inert gas (gs through the fluid line 22 when the accident occurs, in which the molten salt ms inside the reactor 11 is provided with a discharge path fl_l from the inside to the outside of the reactor 11; a step (S140) of surrounding the inert salt liquid layer 51 surrounding the reactor 11, in which the inert salt solid of the inert salt solid layer 52 surrounded by the fluid line 22 is phase-changed into the inert salt liquid through heat of the molten salt ms discharged to the discharge path fl_l provided by the fluid line 22 surrounding the inert salt solid layer 52; and a step (S150) of cooling the nuclear reactor.

Hereinafter, each step will be described.

### Step S110

Referring to FIG. 3, in step S110, a reaction may occur inside the reactor 11 through the molten salt ms.

More specifically, nuclear fuel materials may be eutectic in the molten salt ms inside the reactor 11, and a nuclear reaction may occur in a liquid state in which the nuclear fuel and coolant are integrated.

Accordingly, energy may be generated from the nuclear fuel eutectic in the molten salt ms, in the reactor 11.

Since it overlaps with the description of the above embodiments, the reactor 11 will be referred to the description of the above embodiments.

Meanwhile, referring to FIG. 3, in this step, the inert salt liquid layer 51 may cool the reactor 11 and block the discharge path of the molten salt ms to the outside of the containment vessel 41.

In this regard, it also will be referred to the overlapping description of the above embodiments.

In addition, referring to FIGS. 3 and 4, in this step, the inert salt solid layer 52 may form an insulating layer by using the inert salt solid, thereby preserving the heat in the reactor 11.

In this regard, it also will be referred to the overlapping description of the above embodiments.

### Step S120

Referring to FIG. 3, in step S120, the inert gas gs may be provided into the reactor 11 through the fluid line 22.

To this end, the gas tank 21 may store the inert gas gs as described above.

Accordingly, the stored inert gas gs, as shown in FIG. 3, may be provided from the gas tank 21 and moved along the movement path fl_g provided by the fluid line 22, and may be provided to the lower inside of the reactor 11 through the fluid entrance 23.

Since the gas tank 21, the fluid line 22, and the fluid entrance 23 are overlaps with the description of the above embodiments, they will be referred to the above embodiments.

Meanwhile, in this step, when the inert gas gs is provided to the lower side of the reactor 11, the inert gas gs may be formed into the gas, that is, the bubble bl inside the reactor 11.

Accordingly, when the gas bl moves from the lower side to the upper side of the reactor 11, the molten salt ms and the gas bl may be separated in the gas-liquid separation unit 12.

Meanwhile, according to the embodiments of the present invention, the bubble bl, as described above, may collect the non-soluble particles (not shown), move from the lower side to the upper side of the reactor 11, and explode in the gas-liquid separation unit 12.

Thus, the non-soluble particles (not shown) may fall from the bubble bl into a predetermined space inside the nuclear reactor 1000, such as a collection space (not shown) for collecting the non-soluble particles (not shown).

Thus, according to the present invention, the molten salt ms and the gas bl obtained by collecting the non-soluble particles (not shown) inside the molten salt ms are separated in the gas-liquid separation unit 12, so that the above-described non-soluble fission products may be separated from the molten salt ms inside the nuclear reactor 1000 and managed.

Since it overlaps with the description of the above embodiments, the gas-liquid separation unit 12 will be referred to the description of the above embodiments.

### Step S130

Referring to FIG. 5, in step S130, the movement path fl_g of the inert gas gs may be blocked through the fluid line 22 when the accident occurs, in which the molten salt ms inside the reactor 11 is provided with a discharge path fl_l from the inside to the outside of the reactor 11.

The discharge path fl_l is provided to the molten salt ms through the fluid line 22 because a pressure inside the fluid line 22 may become lower than a pressure inside the reactor 11 when the movement path fl_g of the inert gas gs is blocked through the fluid line 22 as described above.

Thus, referring to FIG. 5, when the accident occurs, the molten salt ms inside the reactor 11 may be discharged from inside the reactor 11 to the outside through the discharge path fl_l provided by the fluid line 22.

Since it overlaps with the description of the above embodiments, the fluid line 22 will be referred to the description of the above embodiments.

Meanwhile, when the accident does not occur in this step, at least one of the steps S110 and S120 described above may be performed.

### Steps S140 and S150

Referring to FIGS. 5 and 6, in step S140, the inert salt liquid layer 51 surrounding the reactor 11 may be surrounded, in which the inert salt solid of the inert salt solid layer 52 surrounded by the fluid line 22 may be phase-changed into the inert salt liquid through heat of the molten salt ms discharged to the discharge path fl_l provided by the fluid line 22 surrounding the inert salt solid layer 52.

As described above, this may be because the inert salt solid may be phase-changed into the inert salt liquid in the temperature range at which the molten salt ms is melted.

Meanwhile, as described above, the inert salt solid and the inert salt liquid have similar thermal conductivities, however, the inert salt liquid may have better heat transfer characteristics than the inert salt solid due to a convection phenomenon.

Meanwhile, as described above, the containment vessel 41 may surround the fluid line 22 (see FIGS. 5 and 6).

Accordingly, when the accident occurs, in step S140, the molten salt ms discharged to the discharge path fl_l provided by the fluid line 22 may exchange heat between the containment vessel 41 and the inert salt solid layer 52.

Thus, upon the accident, when the inert salt solid of the inert salt solid layer 52 is phase-changed into the inert salt liquid in step S140, the reactor 11 may be cooled through the inert salt liquid having the better heat transfer properties than the inert salt solid in step S150.

Thus, according to the present invention, when the accident as described above occurs, a separate apparatus for discharging the molten salt ms inside the reactor 11 to the outside is unnecessary, and therefore, the reactor 11 can be efficiently cooled.

Thus, according to the present invention, in the operating environment of the nuclear reactor 1000, that is, the molten salt nuclear reactor, efficient safety can be achieved from the viewpoint of space and cost.

Since it overlaps with the description of the above embodiments, the inert salt liquid layer 51, the inert salt solid layer 52, and the containment vessel 41 will be referred to the above embodiments.

The nuclear reactor cooling method according to the embodiments of the present invention has been described.

Meanwhile, according to the embodiments of the present invention, the method of designing the nuclear reactor 1000 may be provided.

Hereinafter, the method of designing the nuclear reactor 1000 according to the embodiments of the present invention will be described. In the method of designing the nuclear reactor 1000 according to the embodiments of the present invention described below, the descriptions overlapping with those of the above-described embodiments may be omitted. However, the omission of overlapping descriptions below does not signify that the features according to the present invention are excluded, and the description of the previous embodiment will be referred to for overlapping descriptions below.

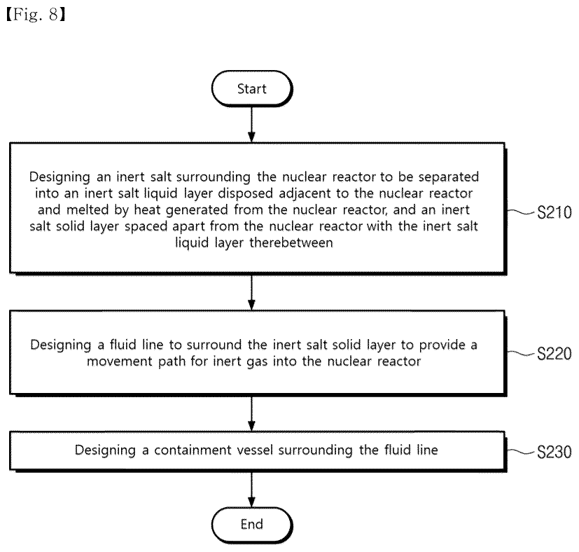

FIG. 8 is a diagram for explaining the nuclear reactor design method according to the embodiments of the present invention.

Referring to FIG. 8, the method of designing the nuclear reactor, in a design method of a nuclear reactor 1000 including inert salt surrounding the reactor 11 for accommodating the molten salt ms, may include at least one of: a step (S210) of designing inert salt surrounding the reactor 11 to be separated into an inert salt liquid layer 51 disposed adjacent to the reactor 11 and melted by heat generated from the reactor 11, and an inert salt solid layer 52 spaced apart from the reactor 11 with the inert salt liquid layer 51 therebetween; a step (S220) of designing the fluid line 22 to surround the inert salt solid layer 52 to provide a movement path fl_g for inert gas gs into the reactor 11; and a step (S230) of designing the containment vessel 41 to surround the fluid line 22.

Hereinafter, each step will be described.

### Step S210

In step S210, the inert salt surrounding the reactor 11 may be designed to be separated into an inert salt liquid layer 51 disposed adjacent to the reactor 11 and melted by heat generated from the reactor 11, and an inert salt solid layer 52 spaced apart from the reactor 11 with the inert salt liquid layer 51 therebetween.

The reactor 11 is disposed inside the nuclear reactor 1000 and may be formed of a material having properties such as oxidation resistance and crack resistance at high temperatures.

Since it overlaps with the description of the above embodiments, the reactor 11, the inert salt liquid layer 51, and the inert salt solid layer 52 will be referred to the above embodiments.

### Step S220

In step S220, the fluid line 22 may be designed to surround the inert salt solid layer 52 to provide the movement path fl_g for the inert gas gs into the reactor 11.

Since it overlaps with the description of the above embodiments, the fluid line 22 will be referred to the description of the above embodiments.

### Step S230

In step S230, the containment vessel 41 may be designed to surround the fluid line 22.

Since it overlaps with the description of the above embodiments, the containment vessel 41 will be referred to the description of the above embodiments.

The nuclear reactor design method according to the embodiments of the present invention has been described.

Meanwhile, according to the embodiments of the present invention, a nuclear reactor cooling module 100 may be provided.

Referring to FIGS. 3 and 5, the nuclear reactor cooling module 100 includes at least one of the gas supply unit 20 and the heat dissipation unit 50 among the configurations of the above-described nuclear reactor 1000 and 1000a.

More specifically, the nuclear reactor cooling module 100 may include at least one of the fluid line 22 for providing a movement path fl_g for the inert gas gs into the reactor 11, the inert salt liquid layer 51 surrounding the reactor 11, and the inert salt solid layer 52 surrounding the inert salt liquid layer 51 and surrounded by the fluid line 22.

In other words, the nuclear reactor cooling module 100 may be included in the above-described nuclear reactor 1000 and 1000a, or may be provided separately and applied to an existing nuclear reactor (not shown).

Thus, according to the present invention, when the accident occurs during operation of the nuclear reactor 1000 and 1000a according to the embodiments of the present invention or the existing nuclear reactor (not shown), the fluid line 22 may block the movement path fl_g of the inert gas gs, and provide the molten salt ms inside the reactor 11 with the discharge path fl_l from the inside of the reactor 11 to the outside, and the inert salt solid of the inert salt solid layer 52 is phase-changed into the inert salt liquid through the heat of the molten salt ms discharged to the discharge path fl_l provided by the fluid line 22 surrounding the inert salt solid layer 52, thereby cooling the reactor 11.

The overlapping description of the nuclear reactor cooling module 100 refer to the description of the above embodiments.

Meanwhile, the embodiments of the present invention may provide a power generation system (not shown) using a nuclear reactor 1000 including the nuclear reactor cooling module 100.

As described above, the power generation system (not shown) may include at least one of the gas supply unit 20 and the heat dissipation unit 50, which are included in the nuclear reactor cooling module 100.

Further, the power generation system (not shown), as described above, may include at least one more of the reaction unit 10, the heat exchange unit 30, and the containment unit 40, which are included in the nuclear reactor 1000 and 1000a.

The overlapping descriptions of the nuclear reactor cooling module 100 and the nuclear reactor 1000 and 1000a refer to the description of the above embodiments.

Hereinafter, experimental examples of the present invention will be described.

Design of nuclear reactor 1000 according to experimental example of the present invention

The reactor 11 for accommodating the molten salt ms is prepared.

The inert salt liquid layer 51 is formed to surround the reactor 11.

The inert salt solid layer 52 is formed to surround the inert salt liquid layer 51.

The fluid line 11 is designed to surround the inert salt solid layer 52 to provide the movement path fl_g for inert gas gs into the reactor 11.

The nuclear reactor 1000 according to the experimental example of the present invention is designed to surround the fluid line 22 by forming the containment vessel 41.

### Design of Nuclear Reactor (cp) According to Comparative Example

In the above-described method of designing the nuclear reactor 1000 according to the experimental example of the present invention, the nuclear reactor cp according to the comparative example is designed without forming the fluid line 22.

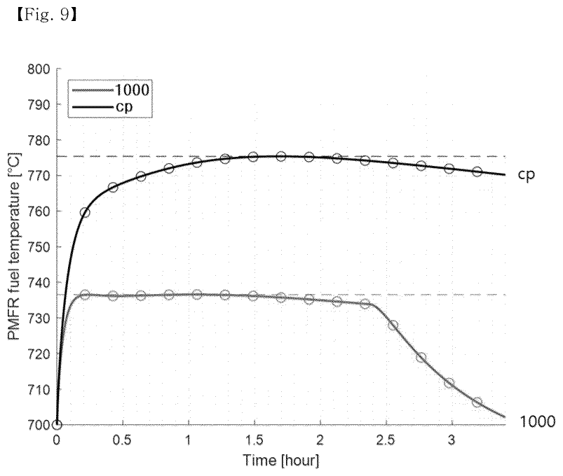

FIGS. 9 to 12 are diagrams for explaining experimental examples of the present invention.

Referring to FIG. 9, when the accident occurs, temperatures of the molten salt ms can be observed in the nuclear reactor 1000 according to the experimental example of the present invention and the nuclear reactor cp according to the comparative example.

It can be seen in FIG. 9 that in the nuclear reactor 1000 according to the experimental example of the present invention when the accident occurs, the temperature of the molten salt ms increases from 700° C. to 736.27° C. and then decreases again to 700° C.

According to the present invention, this may be because, when the accident occurs and the temperature of the molten salt ms increases, the inert salt solid of the inert salt solid layer 52 surrounding the inert salt liquid layer 51 is melted and phase-changed into the inert salt liquid, thereby contributing to cooling.

In addition, this may be because the molten salt ms inside the reactor 11 is discharged from the inside of the reactor 11 to the outside through the fluid line 22.

On the other hand, it can be seen that in the nuclear reactor cp according to the comparative example when the accident occurs, the temperature of the molten salt ms increases from 700° C. to 775.35° C. higher than the temperature of the experimental example 1000 of the present invention and cannot decrease to 700° C. again.

This may be because, according to the comparative example cp, the molten salt ms inside the reactor 11 cannot be discharged from the inside of the reactor 11 to the outside.

Thus, according to the embodiments of the present invention, it can be proven that the nuclear reactor 1000 is cooled when the accident occurs.

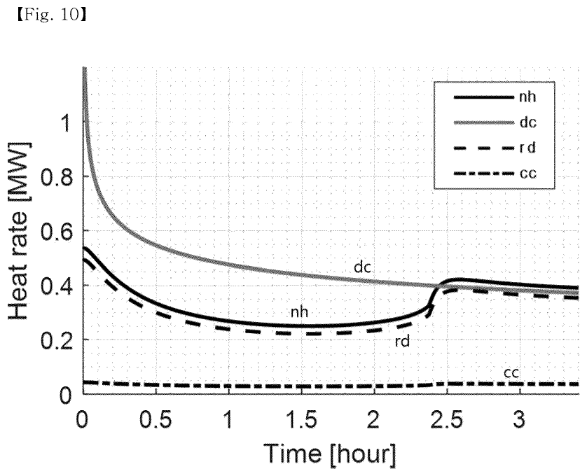

Referring to FIG. 10, it can be observed that when the accident occurs, in the nuclear reactor 1000 according to the experimental example of the present invention, changes in heat removal amounts related to net heat removal nh, decay heat dc, radiation heat rd, and convection heat.

It can be seen from FIG. 10 that since the inert salt solid of the inert salt solid layer 52 is melted as the temperature of the molten salt ms increases in the nuclear reactor 1000 according to the experimental example of the present invention when the accident occurs, the heat removal amounts of the net heat removal nh and the radiation heat rd decrease.

On the other hand, it can be seen that the heat removal amounts of the net heat removal nh and the radiation heat rd increase at the time when all the inert salt solids are melted (about 2.5 hours).

According to the present invention, as described above, this may be because, when the accident occurs and the temperature of the molten salt ms increases, the inert salt solid of the inert salt solid layer 52 surrounding the inert salt liquid layer 51 is melted and phase-changed into the inert salt liquid, thereby contributing to cooling.

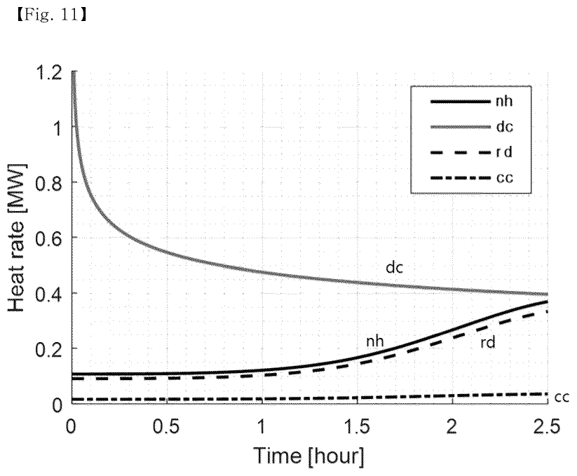

Referring to FIG. 11, it can be observed that when the accident occurs, in the nuclear reactor cp according to the comparative example of the present invention, changes in heat removal amounts related to net heat removal nh, decay heat dc, radiation heat rd, and convection heat.

It can be seen that, based on FIG. 11, when the accident occurs and the temperature of the molten salt ms increases, the heat removal amounts of the net heat removal nh and the radiation heat rd is smaller than the nuclear reactor 1000 according to the experimental example of the invention described above with reference to FIG. 10.

This may be because, unlike the nuclear reactor 1000 of the present invention, the fluid line 22 is not formed in the comparative example, and accordingly the molten salt ms inside the reactor 11 is not discharged from the inside of the reactor 11 to the outside.

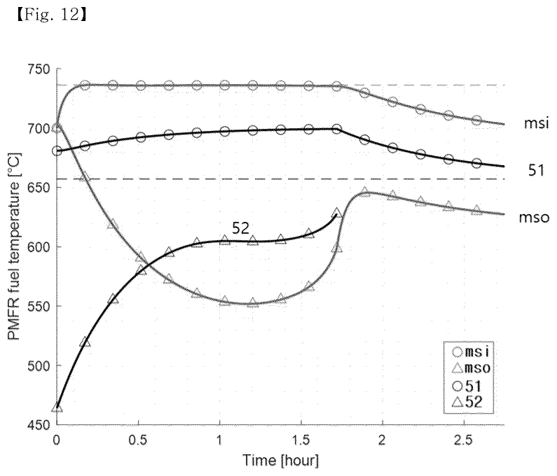

Referring to FIG. 12, when the accident occurs, temperatures of molten salt msi inside the reactor 11, molten salt mso discharged from the inside of the reactor 11 to the outside, an inert salt liquid layer 51, and an inert salt solid layer 52 can be observed in the nuclear reactor 1000 according to the experimental example of the present invention.

It can be seen, based on FIG. 12, when the accident occurs in the nuclear reactor 1000 according to the experimental example of the present invention, the temperature of the molten salt msi inside the reactor 11 increases, and accordingly the temperature of the inert salt solid layer 52 surrounding the internal molten salt msi increases.

Accordingly, when the accident occurs, the inert salt solid in the inert salt solid layer 52 may be phase-changed into the inert salt liquid, and the temperature of the internal molten salt msi may decrease.

In addition, it can be seen that the temperature of the molten salt mso, which is obtained when the molten salt msi inside the reactor 11 is discharged to the outside, decreases through the fluid line 22.

Thus, according to the embodiments of the present invention, it can be proven that the nuclear reactor 1000 is cooled when the accident occurs.

Although the present invention has been described in detail with reference to the preferred embodiments, the present invention is not limited to the specific embodiments and shall be interpreted by the following claims. In addition, it will be apparent that a person having ordinary skill in the art may carry out various deformations and modifications for the embodiments described as above within the scope without departing from the present invention.

What is claimed is:

1. A nuclear reactor cooling module comprising:
a fluid line for providing a movement path for inert gas into a reactor;
an inert salt liquid layer surrounding the reactor; and
an inert salt solid layer surrounding the inert salt liquid layer and surrounded by the fluid line.

2. The nuclear reactor cooling module of claim 1, wherein the fluid line surrounds the inert salt solid layer and is surrounded by a containment vessel containing the reactor, and molten salt discharged through a discharge path provided by the fluid line exchanges heat between the containment vessel and the inert salt solid layer.

3. The nuclear reactor cooling module of claim 2, wherein the inert salt liquid layer cools the reactor, and blocks the discharge path of the molten salt to an outside of the containment vessel.

4. The nuclear reactor cooling module of claim 1, wherein, during normal operation, the inert salt solid layer forms an insulating layer surrounding the inert salt liquid layer by using the inert salt solid to preserve heat in the reactor; and
upon occurrence of an accident, the fluid line blocks the movement path of the inert gas and provide a discharge path from an inside of the reactor to an outside molten salt inside the reactor, and the inert salt solid is phase-changed into an inert salt liquid in a temperature range at which the molten salt is melted, through heat of the molten salt discharged to the discharge path provided by the fluid line surrounding the inert salt solid layer, thereby cooling the reactor.

5. A power generation system using a nuclear reactor, the power generation system comprising a nuclear reactor cooling module of claim 1.

6. The power generation system of claim 5, further comprising:
an auxiliary cooling unit for containing a reactor therein to cool a containment vessel surrounding a fluid line.

7. The power generation system of claim 5, further comprising:
a fluid line heat exchanger for cooling the fluid line.

8. The power generation system of claim 5, further comprising:
a gas tank for storing inert gas provided through the fluid line; and
a fluid entrance provided at a lower side of the reactor to discharge the inert gas stored in the gas tank to a lower inside of the reactor, wherein, when the accident occurs, the gas tank stops providing the inert gas, and molten salt inside the reactor is introduced into the fluid entrance.

9. A nuclear reactor cooling method comprising:
causing a reaction through molten salt inside a reactor;
providing inert gas to an inside of the reactor through a fluid line;
blocking, upon occurrence of an accident, a movement path of the inert gas through the fluid line and providing the molten salt inside the reactor with a discharge path from the inside of the reactor to an outside thereof;
surrounding an inert salt liquid layer surrounding the reactor, in which an inert salt solid of an inert salt solid layer surrounded by the fluid line is phase-changed into an inert salt liquid through heat of the molten salt discharged to the discharge path provided by the fluid line surrounding the inert salt solid layer; and
cooling the reactor.

10. The nuclear reactor cooling method of claim 9, wherein the cooling of the reactor includes: allowing the molten salt to exchange heat between a containment vessel surrounding the fluid line and the inert salt solid layer.

11. The nuclear reactor cooling method of claim 10, wherein the causing of the reaction includes:
allowing the inert salt liquid layer to cool the reactor and block the discharge path of the molten salt to an outside of the containment vessel.

12. The nuclear reactor cooling method of claim 9, wherein the causing of the reaction includes: allowing the inert salt solid layer to form an insulating layer by using the inert salt solid to preserve heat of the reactor; and
the phase-changing includes: allowing the inert salt solid to be phase-changed into the inert salt liquid in a temperature range at which the molten salt is melted, thereby cooling the reactor.

13. A design method of a nuclear reactor including inert salt surrounding a reactor for accommodating molten salt, the design method comprising:
designing an inert salt surrounding the reactor to be separated into an inert salt liquid layer disposed adjacent to the reactor and melted by heat generated from the reactor, and an inert salt solid layer spaced apart from the reactor with the inert salt liquid layer therebetween.

14. The design method of claim 13, further comprising:
designing a fluid line to surround the inert salt solid layer to provide a movement path for inert gas into the reactor; and
designing a containment vessel surrounding the fluid line, wherein
the molten salt discharged through the discharge path provided by the fluid line is designed to exchange heat between the containment vessel and the inert salt solid layer.
